(19) United States
(12) Patent Application Publication
(10) Pub. No.: US 2012/0093518 A1
(43) Pub. Date: Apr. 19, 2012

(54) SINGLE PACKAGE BIDIRECTIONAL MODULE FOR MULTIMODE FIBER COMMUNICATION

(75) Inventors: Carlo Tosetti, Sondrio (IT); Damiano Rossetti, Monza (IT); Marco Mazzini, Milano (IT)

(73) Assignee: CISCO TECHNOLOGY, INC., San Jose, CA (US)

(21) Appl. No.: 12/903,682

(22) Filed: Oct. 13, 2010

(51) Int. Cl. H04J 14/02; H04B 10/00

(52) U.S. Cl. 398/135; 398/79

(57) ABSTRACT

In one embodiment an apparatus is provided for supporting 100GBASE-SR10 data communications over an optical link. The apparatus includes a receptacle configured to receive an optical fiber cable comprising at least 10 OM3 optical fibers, the receptacle including individual channels for receiving respective ones of the at least 10 optical fibers, a plurality of optical receiver/transmitter pairs, and a plurality of wave division multiplexers configured to couple individual ones of the channels with respective ones of the optical receiver/transmitter pairs.

### TECHNICAL FIELD

The present disclosure relates to data communications, particularly data communications using optical fiber.

### BACKGROUND

Current 100GBASE-SR10 PMD (physical medium dependent) is targeted for a reach of 100 meters over optical multimode (OM) OM3 fiber ribbon using parallel transmission of 20 channels at a rate of 10GE each (10 in the transmit (TX) direction plus 10 in the receive (RX) direction). In order to transmit and receive the 20 channels that are required to connect two, e.g., C-form factor pluggable (CFP) optical transceivers, a proposed IEEE standard requires connecting the endpoint transceivers using one 24 or two 12 multimode fiber ribbon cable(s) (where only 20 fibers are actually used—10 each for TX and RX).

In a similar way, current 40GBASE-SR4 PMD is targeted for the same reach of 100 meters over the same type of multimode fiber (OM3), using parallel transmission of 8 channels at a rate of 10GE each (4 in the TX direction plus 4 in the RX direction). In the 40GBASE-SR4 case, the use of a standard 12 fiber ribbon cable is proposed (where only 8 fibers are actually used).

### BRIEF DESCRIPTION OF THE DRAWINGS

FIG. 1 shows two C form-factor pluggable (CFP) modules connected by a fiber optic cable.

FIG. 2 shows an architecture for bidirectional communication over a single channel that corresponds to a single optical fiber within the fiber optic ribbon cable.

FIG. 3 shows an example implementation of transmit and receive wavelengths for bidirectional communication over each channel.

FIG. 4 shows link connections between two 100GBASE-SR10 CFP modules.

FIG. 5 shows an example lane (or channel) assignment for a 12 fiber ribbon connector to support 100GBAE-SR10 data communications.

### DESCRIPTION OF EXAMPLE EMBODIMENTS

Overview

An apparatus (such as an optical pluggable transceiver) is provided that includes, a receptacle configured to receive an optical fiber cable comprising at least 10 OM3 optical fibers, the receptacle including individual channels for receiving respective ones of the at least 10 optical fibers, a plurality of optical receiver/transmitter pairs, and a plurality of wave division multiplexers configured to couple individual ones of the channels with respective ones of the optical receiver/transmitter pairs, wherein, together, the individual channels support 100GBASE-SR10 bidirectional data communications.

### Example Embodiments

Recently, a multi-source agreement (MSA) has been developed to specify a common form-factor pluggable device for the transmission high-speed optical digital signals. The MSA provides for the so-called C form-factor pluggable (CFP) optical transceiver. The “C” stands for the Latin letter C, which is used to express the number 100 (centum), as the MSA is geared for 100 Gigabit Ethernet systems, namely 100GBASE-SR10.

While the deployment of 100GBASE-SR10 is highly desirable, it is not a simple task to upgrade from existing 40GBASE-SR10 optical fiber cable infrastructures to optical fiber cable infrastructure that supports the faster 100GBASE-SR10. Specifically, even if the individual link properties of the fiber medium are exactly the same for both 40GBASE-SR10 and 100GBASE-SR10, different ribbon cables have to be used, preventing the possibility of re-using the cable infrastructure when upgrading from 40BASE-SR10 to 100BASE-SR10.

More specifically, as presently contemplated, upgrading from 40GBASE-SR10 to 100GBASE-SR10 requires a completely new 24 fiber ribbon cable (with 10 fibers used for transmit and another 10 fibers used for receive), which is not compatible with 40GBASE-SR4 (which uses only a single 12 fiber ribbon). Thus, to upgrade from a 40GBASE-SR4 fiber infrastructure to 100GBASE-SR10, an additional 12 fiber ribbon cable for each link is needed, doubling the quantity of installed cables.

Described herein is an approach that enables upgrading from 40GBASE-SR4 to 100BASE-SR10, but doing so without any change in the installed cable infrastructure that supports 40GBASE-SR4, thereby saving a 12 fiber ribbon cable (or a completely new 24 fiber ribbon cable) for each 100G link.

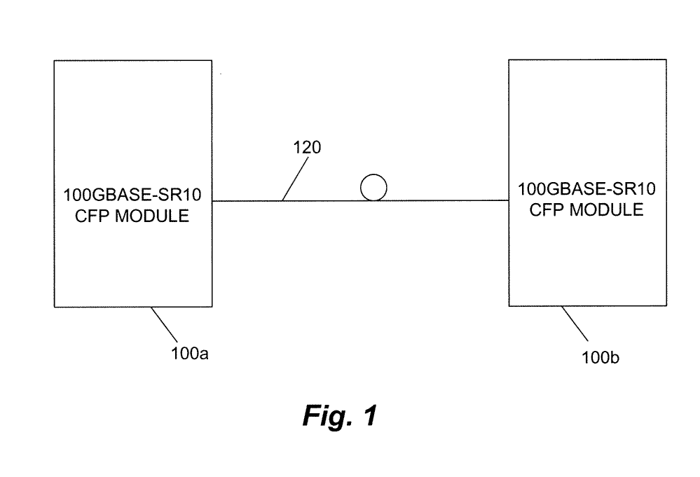

FIG. 1 depicts two CFP transceiver modules 100a, 110b connected to each other via a fiber optic cable 120, such as a ribbon cable comprising 12 individual fibers. Each of the fibers in the cable 120 may also be referred to as a “lane” or “channel.”

In order to avoid having to upgrade the cable 120 from a 12 fiber ribbon cable to a 24 fiber ribbon cable (or two 12 fiber ribbons) in order to support 100GABSE-SR10 data communications, the CFP modules 100a, 100b themselves are modified as explained below.

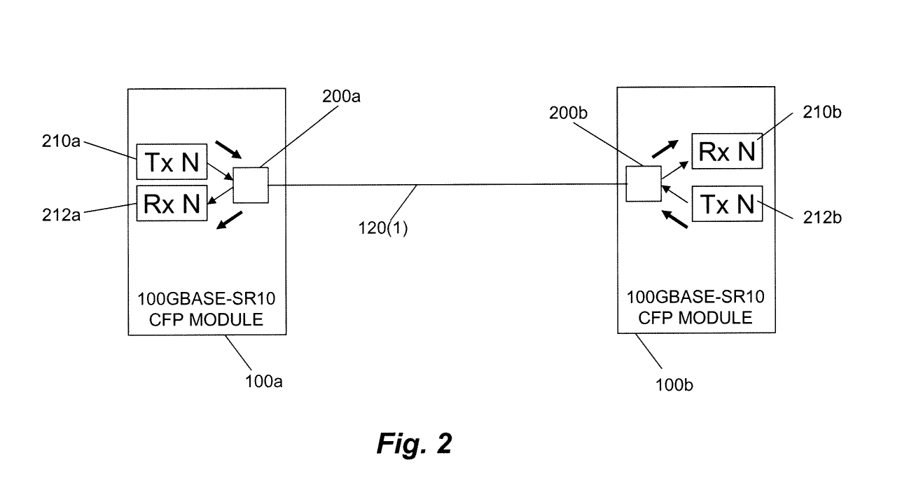

FIG. 2 shows an architecture for bidirectional communication using a single channel, e.g., 120(1), that corresponds to a single optical fiber within the fiber optic cable 120. While FIG. 2 focuses on a single 10G link, those skilled in the art will appreciate that the same architecture may be applied to all 10 lanes that are used, as will be seen, to support 100GBASE-SR10 data communications. To implement the bidirectional link (and referring, for the moment, only to the left hand CFP module 100a), a wave division multiplexer (WDM) filter 200a is used inside the transceiver to multiplex/demultiplex optical signals that are configured to travel in opposite directions.

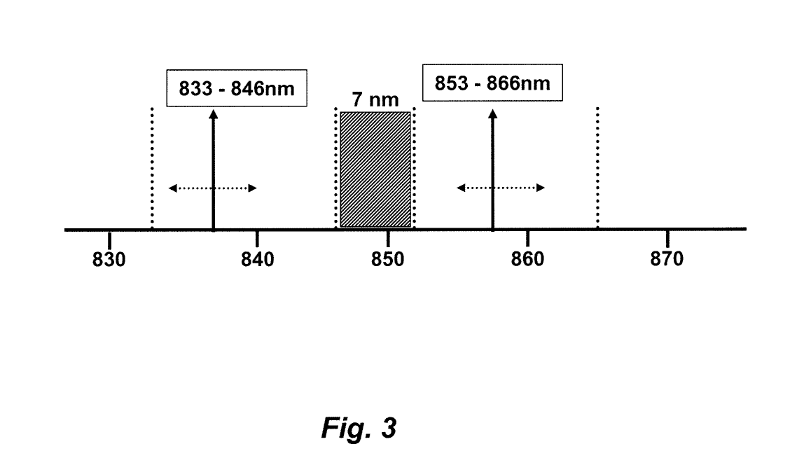

FIG. 3 shows an example implementation of transmit and receive wavelengths to implement the bidirectional communication. In this example, an uncooled laser operation is contemplated, but those skilled in the art will appreciate that the same approach can be applied in a cooled regime. As shown in FIG. 3, the wavelength window for the downstream signal is 833-846 nm (referred to herein generally as 845 nm), while the wavelength window for the upstream signal is from 853-866 nm (referred to herein generally as 855 nm). A 7 nm guard band, centered around 850 nm may be implemented to ensure separation between the opposite flowing signals.

Referring again to FIG. 2, each CFP module 100a, 100b includes a transmitter/receiver pair 210a, 212a and 210b, 212b that is coupled, respectively, to a WDM 200a, 200b. Thus, bidirectional communication over the same fiber is enabled. It is noted that bidirectional transceivers have been used for lower bit rates in order to save installed fiber (e.g., one fiber instead of two). However, a drawback of such architectures is that such bidirectional transceivers require two different package configurations (sometimes referred to in the art as package identifiers (“PIDs”)), one for the upstream endpoint and one for the downstream endpoint.

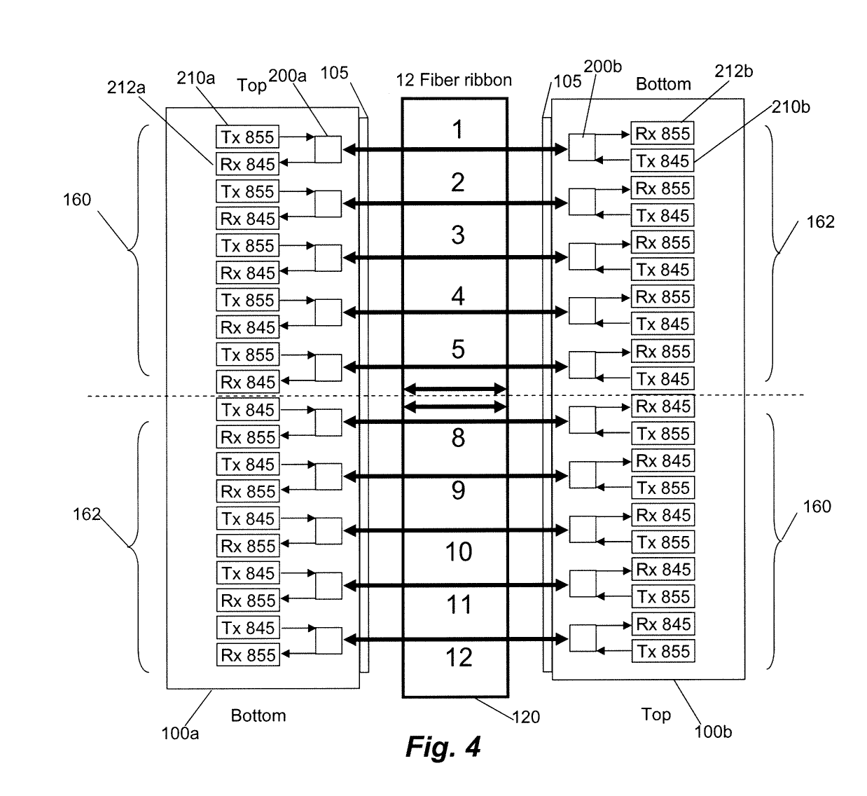

In contrast, a single or universal configuration of the CFP modules 100a, 100b described herein provides both endpoints in an overall system, i.e., the same CFP module supports both upstream and downstream transceiver endpoints. In other words, there is no difference between CFP modules 100a, 100b—those designations being used only to differentiate between the two end points in the instant drawings. A single CFP module PID for both endpoints is achieved with a particular spatial allocation of the upstream and downstream wavelengths shown in FIG. 4, which also shows link connections between two 100GBASE-SR10 CFP modules 100a, 100b.

For simplicity, CFP module 110a is described. However, as noted above, the CFP module 100b is identically configured. As is seen, the CFP module 100a includes two portions: a top portion 160 and bottom portion 162 (these, of course, could be arranged as left and right sides as well if the drawing were rotated by 90 degrees). Top portion 160 includes five WDMs 200a each respectively coupled to a lane or channel of the optical fiber cable 120. The WDMs 200a are also coupled to respective transmitter/receiver pairs 210a, 212a. The top most transmitter/receiver pair transmits at 855 nm and receives at 845 nm. This arrangement is repeated for all five transmitter/receiver pairs 210a, 212a in the top portion 160 of the CFP module 110a.

The five transmitter/receiver pairs 210a, 212a in the bottom portion 162 of CFP module 100a are arranged inversely. That is, in the bottom portion 162, the transmitter/receiver pairs 210a, 212a transmit at 845 nm and receive at 855 nm. Consequently, one can take the same CFP module 100a and use it in the same position as CFP module 100b. More specifically, if CFP module 100a is rotated 180 degrees in the plane of the drawing sheet, the top portion 160 becomes the bottom portion 162, and the bottom portion 162 becomes the top portion 160. As a result of the spatial allocation of wavelengths, the transmit and receive wavelengths of transmitter/receiver pair 210a, 212a of CFP module 100a (855 nm and 845 nm) match, inversely, with the transmitter/receiver pair 210b, 212b of CFP module 100b (845 nm, 855 nm).

Still referring to FIG. 4, lanes 1-5 of fiber optic ribbon cable 120 are coupled (e.g., via a receptacle 105) to the top portion 160 of CFP module 100a, and lanes 8-12 of fiber optic ribbon cable 120 are coupled to the bottom portion 162 of CFP module 100a. The two middle lanes, namely lanes 6 and 7 of a 12 fiber ribbon cable 120, are not used in this embodiment, as only 10 lanes are utilized to achieve full bidirectional 100GBASE-SR10 data communication (10G per lane).

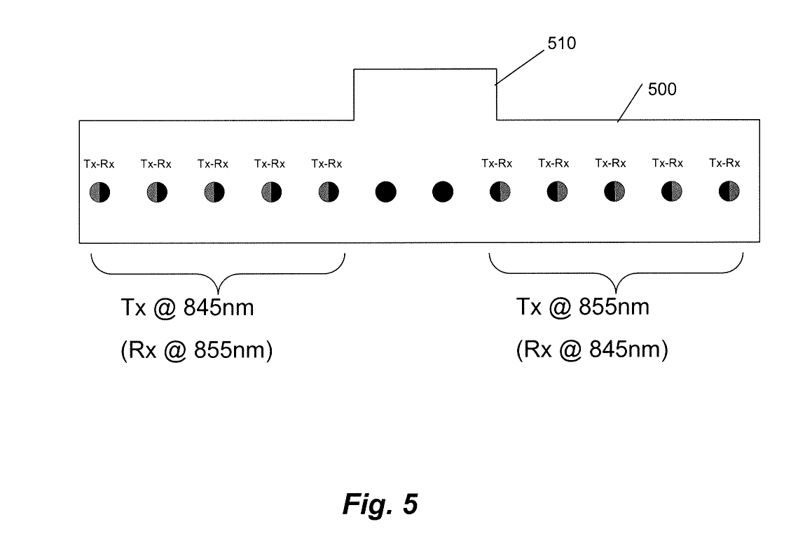

FIG. 5 shows an example lane (channel) assignment for a 12 fiber ribbon connector that would be received by receptacle 105 on the CFP module 100a. Assuming the connector 500 is oriented with key portion towards the left (i.e., the connector 500 is rotated counter clockwise by 90 degrees), the lane assignments match precisely with the spatial channel allocation of CFP module 100a. Likewise, if the connector is rotated clockwise, then the lane assignments match precisely with the spatial channel allocation of CFP module 100b. As can be seen, the two middle lanes in connector 500 are not used, as only 10 lens are need to support 100GBASE-SR10 bidirectional data communications.

Thus, as will be appreciated by those skilled in the art, a single PID bidirectional multimode 100GBASE-SR10 optical transceiver which is compatible with 40GBASE-SR4 12-fiber ribbon infrastructure is provided. Such a device enables an upgrade from 40G Ethernet to 100G Ethernet, without having to change fiber infrastructure. Further, unlike the proposed IEEE approach, a single 12-fiber ribbon may be used instead of dual 12-fiber ribbon cables or a single 24-fiber ribbon cable.

Furthermore, a single PID implementation (even if bidirectional) is provided that can be used at both endpoints of an optical data link using optical fiber.

Although the system and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following.

What is claimed is:

1. An apparatus, comprising:
a receptacle configured to receive an optical fiber cable comprising at least 10 optical multimode 3 (OM3) optical fibers, the receptacle including individual channels for receiving respective ones of the at least 10 optical fibers;
a plurality of optical receiver/transmitter pairs; and
a plurality of wave division multiplexers configured to couple individual ones of the channels with respective ones of the optical receiver/transmitter pairs,
wherein, together, the individual channels support 100GBASE-SR10 bidirectional data communications.

2. The apparatus of claim 1, wherein the optical fiber cable comprises 12 optical fibers and two of 12 channels corresponding to two optical fibers are not communicatively coupled to any of the optical receiver/transmitter pairs.

3. The apparatus of claim 2, wherein two middle channels of the receptacle are not communicatively coupled to any of the optical receiver/transmitter pairs.

4. The apparatus of claim 1, wherein each channel supports 10 Gbit/second bidirectional data communication.

5. The apparatus of claim 1, wherein the receptacle has a first portion and a second portion, and wherein the optical receiver/transmitter pairs in the first portion receive at a first wavelength and transmit at a second wavelength, and the optical receiver/transmitter pairs in the second portion receive at the second wavelength and transmit at the first wavelength.

6. The apparatus of claim 5, wherein the first wavelength is about 855 nm.

7. The apparatus of claim 5, wherein the second wavelength is about 845 nm.

8. The apparatus of claim 5, wherein a guard band of about 7 nm separates the first wavelength and the second wavelength.

9. The apparatus of claim 1, wherein the apparatus is a 100 Gbit/second C-form factor pluggable (CFP) transceiver.

10. The apparatus of claim 1, wherein each channel is configured to support both upstream and downstream data communications at a 10 Gbit/second data rate.

11. An apparatus, comprising:
a receptacle having a first portion and a second portion;
a plurality of optical receiver/transmitter pairs; and
a plurality of wave division multiplexers configured to couple individual ones of fiber optic channels received at the receptacle with respective ones of the optical receiver/transmitter pairs,
wherein optical receiver/transmitter pairs arranged in the first portion of the receptacle receive at a first wavelength and transmit at a second wavelength, and optical receiver/transmitter pairs arranged in the second portion of the receptacle receive at the second wavelength and transmit at the first wavelength, and
wherein, together, the individual channels support 100GBASE-SR10 data communications.

12. The apparatus of claim 11, wherein the receptacle is configured to receive an optical fiber cable comprising at least 10 optical multimode 3 (OM3) optical fibers.

13. A method, comprising:
deploying a first C-form factor pluggable transceiver at a first endpoint of an optical network and a second C-form factor pluggable transceiver at second endpoint of the optical network, wherein the first and the second C-form factor pluggable transceivers are configured identically;
connecting the first and the second C-form factor pluggable transceivers together via a multi-fiber optical fiber ribbon cable comprising no more than 12 optical fibers; and
simultaneously transmitting and receiving optical signals via at least 10 optical fibers of the multi-fiber optical fiber ribbon cable to support 100GBASE-SR10 bidirectional data communications.

14. The method of claim 13, further comprising using respective wave division multiplexers to enable bidirectional data communication via each of the at least 10 optical fibers of the multi-fiber optical fiber ribbon cable.

15. The method of claim 14, wherein transmitting and receiving comprises transmitting and receiving at 10 Gbits/second on each of the at least 10 optical fibers of the multi-fiber optical fiber ribbon cable.

16. The method of claim 13, further comprising,
in a first portion of the C-form factor pluggable transceiver, transmitting optical signals via a wave division multiplexer at a first wavelength and receiving optical signals via the wave division multiplexer at a second frequency; and
in a second portion of the C-form factor pluggable transceiver, transmitting optical signals via another wave division multiplexer at the second wavelength and receiving optical signals via the another wave division multiplexer at the first frequency.

17. The method of claim 16, wherein the first wavelength is about 855 nm.

18. The method of claim 16, wherein the second wavelength is about 845 nm.

19. The method of claim 16, further comprising maintaining a guard band of about 7 nm between the first wavelength and the second wavelength.

20. The method of claim 13, further comprising upgrading from 40GBASE-SR4 bidirectional data communications to 100GBASE-SR10 bidirectional data communications using a same multi-fiber optical fiber ribbon cable previously used for the 40GBASE-SR4 bidirectional data communications.
